(19) United States
(12) Patent Application Publication
(10) Pub. No.: US 2009/0200873 A1
(43) Pub. Date: Aug. 13, 2009

(54) INDUCTION-TYPE POWER SUPPLY AND SYSTEM

(76) Inventors: Chienchung Lee, Taipei City (TW); Lushan Chang, Danshuei Township (TW); Shihwei Tung, Taipei City (TW); Kuoliang Lee, Taipei City (TW); Chihhao Chen, Dali City (TW); Hsiaoching Wang, Sindian City (TW)

Correspondence Address: KENING LI;PINSENT MASONS LLP, c/o FOUNTAIN LAW GROUP, INC, 18201 Von Karman Avenue, Suite 960, Irvine, CA, 92612, US

(21) Appl. No.: 12/361,650

(22) Filed: Jan. 29, 2009

(30) Foreign Application Priority Data
Jan. 30, 2008 (CN) 97103448

(51) Int. Cl. H02J 17/00

(52) U.S. Cl. 307/104

(57) ABSTRACT

An inductive power supply device comprises a battery module, an induction coil module, and a magnetic control module connected to the induction coil module. The magnetic control module comprises a main control module, a coil-driving module, an interface module, a circuit protection module and a wireless identification module. The coil-driving module, the interface module, the circuit protection module and, the wireless identification module are all electrically connected to the main control module respectively. The present invention also provides an inductive power supply system, which supplies a common platform of power supply to all household appliances, and brings a great convenience to users.

### CROSS REFERENCE TO RELATED APPLICATIONS

The present application claims priority to Republic of China Patent Application No. Serial No: 97103448, filed on Jan. 30, 2008, the entire disclosure of which is incorporated herein by reference.

### FIELD OF THE INVENTION

The present invention relates to a power supply for household appliances, more particularly to an inductive power supply device and system comprising the same.

### RELATED ART

As the technology develops, more and more household appliances come into people's lives which bring great advantages. Such household appliances use electricity as power supply for functioning. For example, the water heater heats water by transferring the electrical energy into heat energy via electronic element, and the mixer achieves its mixing function via the motor driven by electrical energy to drive relevant parts. Household appliances often are operated by batteries that are either rechargeable or non-rechargeable. The household appliance of rechargeable mode must be charged by a charger periodically, while the household appliance of non rechargeable mode is supplied power by its power plug connected to the electric supply directly. Different household appliances, however, of rechargeable mode need different chargers. As the number of household appliances in the home increases, more and more chargers are needed, causing cluttering.

### SUMMARY OF THE INVENTION

The present invention provides an inductive power supply device and system, whose primary object is to overcome the above disadvantages of the conventional power supply, providing a common platform of power supply. Such object of the present invention will become apparent in the ensuing description:

In one embodiment, an inductive power supply of the present invention comprises:
a battery module;
an induction coil module; and
a magnetic control module connected to the induction coil module, wherein the magnetic control module comprises a main control module, a coil-driving module, an interface module, a circuit protection module and a wireless identification module; and wherein the coil-driving module, the interface module, the circuit protection module and, and the wireless identification module are all electrically connected to the main control module respectively.

In another embodiment, the inductive power supply system is provided which comprises:
a battery module;
a magnetic control module electrically connected to the battery module, wherein the magnetic control module comprises a first main control module, a coil-driving module, a first interface module, a first circuit protection module and a first wireless identification module; and wherein the coil-driving module, the first interface module, the first circuit protection module and the first wireless identification module are respectively connected to the first main control module;
a first induction coil module;
a second induction coil module; and
a power control module electrically connected to the second induction coil module; wherein the power control module comprises a second main control module, a power output module, a second interface module, a second circuit protecting module and a second wireless identification module, wherein the power output module, the second interface module, the second circuit protecting module and the second wireless identification module are electrically connected to the second main control module; wherein the power output module is electrically connected to a household appliance, wherein the first wireless identification module provides appropriate electric current to the first induction coil module via the first and second wireless identification module, the first induction coil module generates a magnetic force and the magnetic force passes through the second induction coil module to generate an inductive current, and the inductive current is input into the power control module; the second main control module drives the power output module to provide electric power to the household appliance equal to the power demand of the household appliance.

Compared to prior art power supplies, the present invention has the following advantages. The first main control module provides appropriate electrical current to the first induction coil module via the first and second wireless identification module, the first induction coil module generates a magnetic force and the magnetic force passes through the second induction coil module to generate an inductive current and the inductive current is input into the power control module, the second main control module drives the power output module to provide electric power for the household appliance equal to the power demand of the household appliance. Thus, all household appliances can get power from the inductive power supply system of the present invention. This provides a common platform of power supply for all household appliance and overcomes the disadvantages of needing different power supplies for different household appliances.

The following is a description of the present invention referring to the drawings and preferred embodiments, which description is not intended to be exhaustive or to limit the invention.

### BRIEF DESCRIPTION OF THE DRAWINGS

FIG. 1 is a block diagram of the inductive power supply structure in embodiment 1 of the present invention.

FIG. 2 is a block diagram of the inductive power supply structure in embodiment 2 of the present invention.

FIG. 3 is a block diagram of the inductive power supply structure in embodiment 3 of the present invention.

FIG. 4 is a block diagram of the inductive power supply structure in embodiment 4 of the present invention.

FIG. 5 is a block diagram of the inductive power supply system in embodiment 4 of the present invention.

FIG. 6 is a structure sketch map of the inductive power supply system of the present invention.

### DETAILED DESCRIPTION OF EXEMPLARY EMBODIMENTS

### Embodiment 1

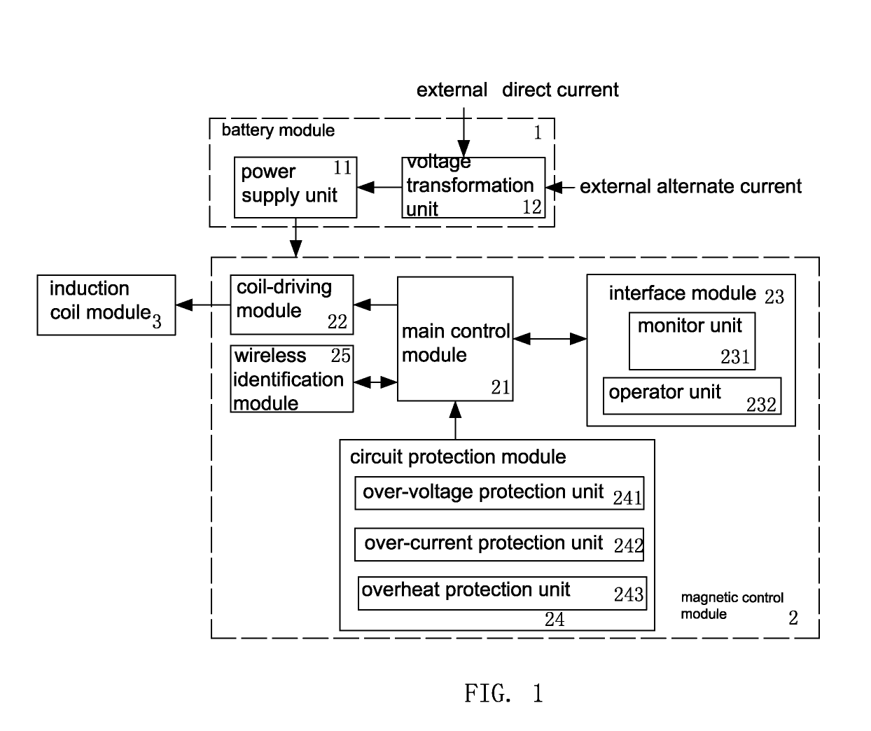

Referring to FIG. 1, an inductive power supply structure of the present invention includes a battery module 1 for supplying electrical energy, a magnetic control module 2 for controlling the power supply of the battery module 1, and an induction coil module 3.

The output of the battery module 1 is connected to the magnetic control module 2; the output of the magnetic control module 2 is connected to the induction coil module 3; the battery module 1 supplies electrical energy to the induction coil module 3 via controlling the magnetic control module 2.

The magnetic control module 2 includes a main control module 21, a coil-driving module 22, an interface module 23, a circuit protection module 24 and a wireless identification module 25. The coil-driving module 22, the interface module 23, the circuit protection module 24 and the wireless identification module 25 are all connected to the main control module 21 respectively. The input of the coil-driving module 22 is connected to the output of the battery module 1. The output of the coil-driving module 22 is connected to the induction coil module 3. The coil-driving module 22 supplies driving electrical current to the induction coil module 3.

The battery module 1 comprises a power supply unit 11 and a voltage transformation unit 12. The input of the voltage transformation unit 12 is connected to an external alternate current (AC) or direct current (DC). The voltage transformation unit 12 is used to change the external alternate current into direct current and to reduce voltage or to adjust the voltage of direct current. The output of the voltage transformation unit 12 is connected to the input of the power supply unit 11. The output of the power supply unit 11 is connected to the magnetic control module 2.

The interface module 23 comprises a monitor unit 231 and an operator unit 232. The monitor unit 231 shows whether the magnetic control module 2 is supplying electrical current to the induction coil module 3. Users can determine whether to supply electrical energy to the induction coil module 3 via the operator unit 232.

The circuit protection module 24 comprises an over-voltage protection unit 241, an over-current protection unit 242 and an overheating protection unit 243. The over-voltage protection unit 241, the over-current protection unit 242 and the overheating protection unit 243 are used to protect the magnetic control module 2 from over-voltage, over-current or overheating respectively to prolong its service life.

The wireless identification module 25 is used to send and receive wireless signal. The wireless signal that the wireless identification module 25 receives is transmitted to the main control module 21 for processing.

### Embodiment 2

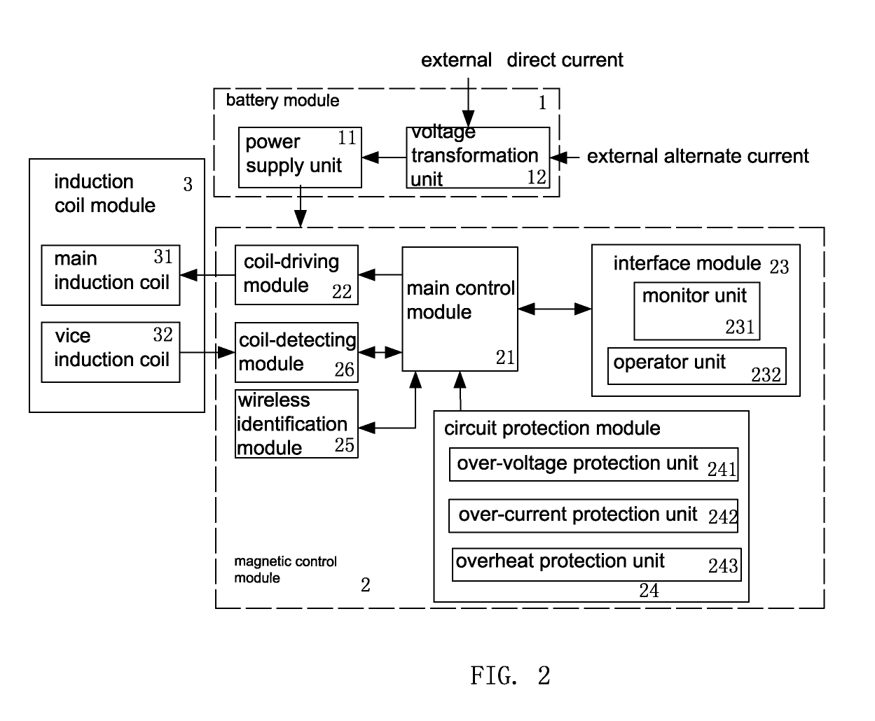

The inductive power supply structure depicted in FIG. 2 differs form that of Embodiment 1 in the following aspects. The magnetic control module 2 further comprises a coil-detecting module 26. The induction coil module 3 comprises a main induction coil 31 and a vice induction coil 32. The coil-detecting module 26 is connected to the main control module 21. The main induction coil 31 is connected to the output of the coil-driving module 22. The output of the vice induction coil 32 is connected to the coil-detecting module 26.

### Embodiment 3

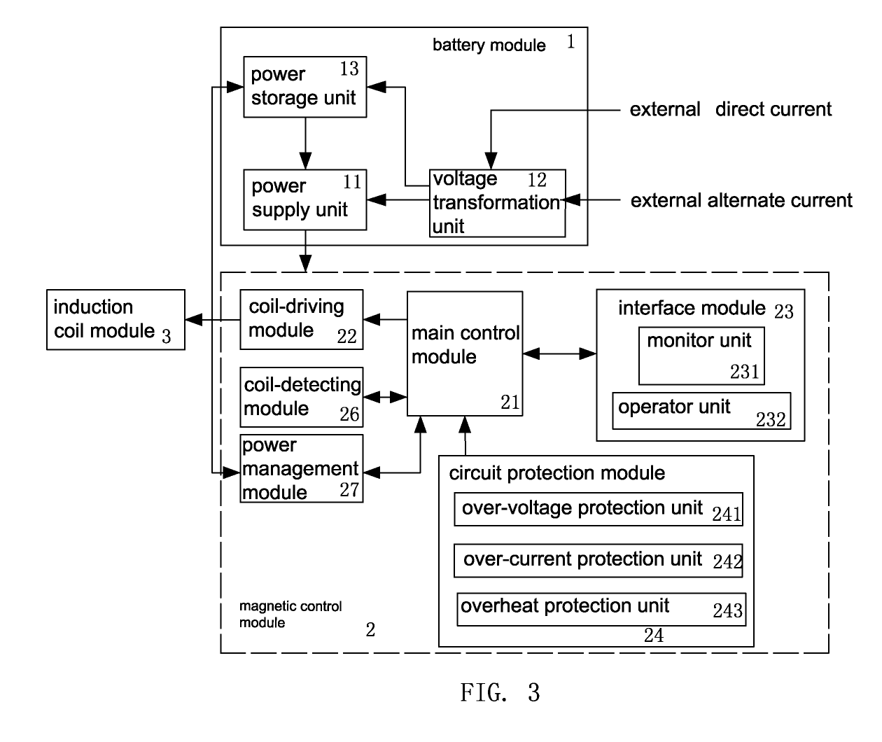

The inductive power supply structure depicted in FIG. 3 differs form that of Embodiment 1 in the following aspects. The battery module 1 also comprises a power storage unit 13. The magnetic control module 2 also comprises a power management module 27. The input of the voltage transformation unit 12 is connected to the external alternate current or direct current. The output of the voltage transformation unit 12 is connected to the input of the power supply unit 11. The output of the power supply unit 11 is connected to the magnetic control module 2. The input of the power storage unit 13 is connected to the output of the voltage transformation unit 12. The power storage unit 13 is connected to the power management module 27. The power management module 27 is connected to the main control module 21. The power storage unit 13 is used for storing electric energy. In the off-peak time of electricity use, electrical energy is stored in the power storage unit 13, and in the peak time of use of electricity the electrical energy stored in the power storage unit 13 is supplied for household appliances via the power supply unit 11, which can save power cost.

### Embodiment 4

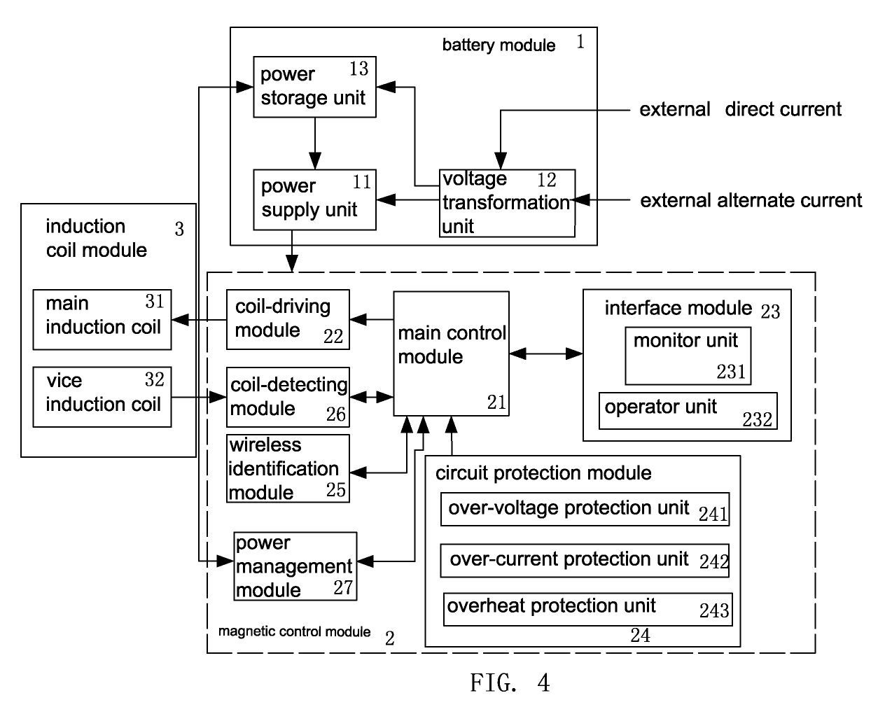

The inductive power supply structure depicted in FIG. 4 differs form that of Embodiment 1 in the following aspects. The battery module 1 also comprises a power storage unit 13. The magnetic control module 2 also comprises a coil-detecting module 26 and a power management module 27. The induction coil module 3 comprises a main induction coil 31 and a vice induction coil 32. The coil-detecting module 26 is connected to the main control module 21. The main induction coil 31 is connected to the output of the coil-driving module 22. The output of the vice induction coil 32 is connected to the coil-detecting module 26. The input of the voltage transformation unit 12 is connected to the external alternate current or direct current. The output of the voltage transformation unit 12 is connected to the input of the power supply unit 11. The output of the power supply unit 11 is connected to the magnetic control module 2. The input of the power storage unit 13 is connected to the output of the voltage transformation unit 12. The power storage unit 13 is connected to the power management module 27. The power management module 27 is connected to the main control module 21.

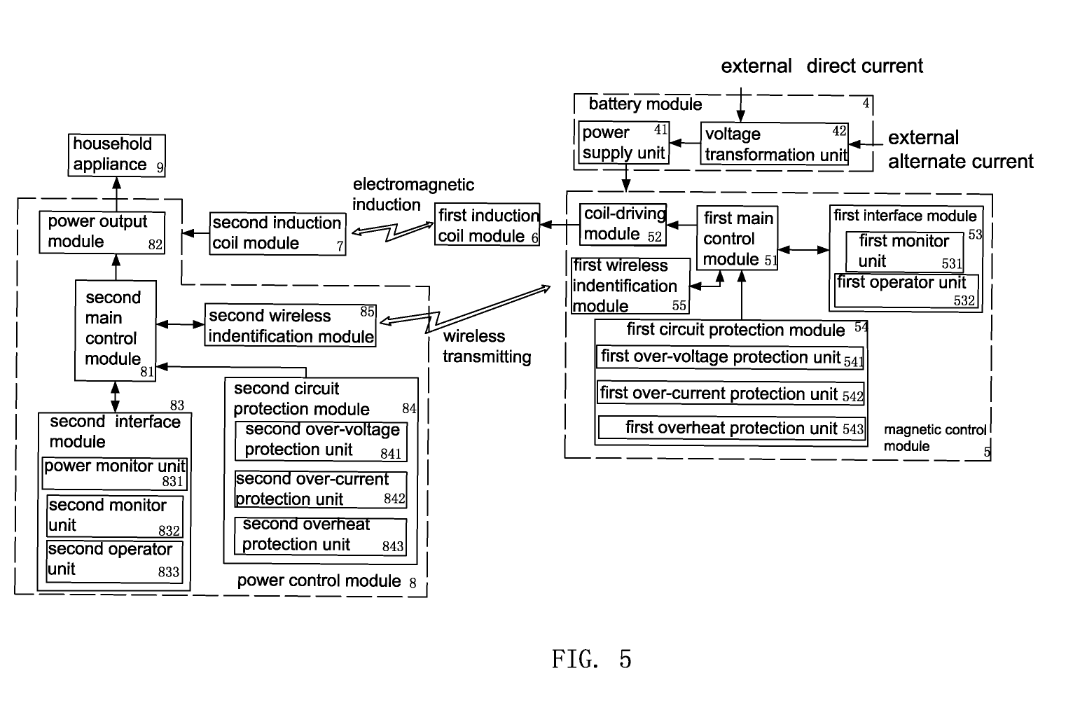

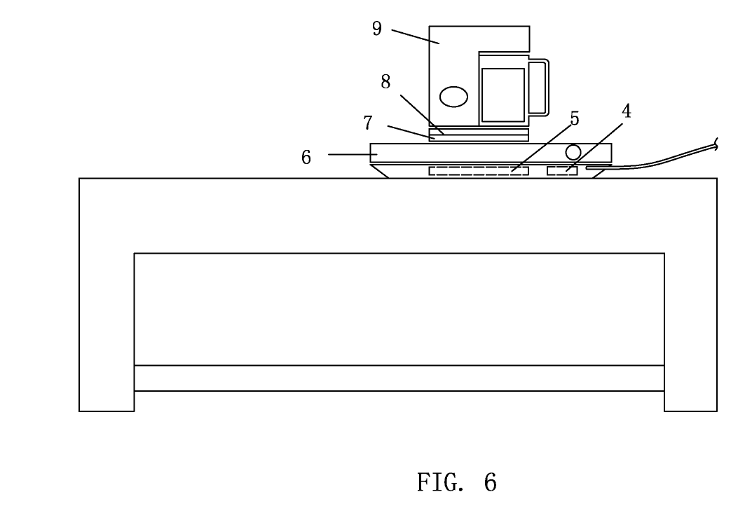

Referring to FIGS. 5 and 6, an inductive power supply system of the present invention comprises a battery module 4 for supplying electrical energy, a magnetic control module 5 for controlling the power supply of the battery module 4, a first induction coil module 6, a second induction coil module 7 that can generate electromagnetic induction with the first induction coil module 6, and a power control module 8 that is used to supply electrical energy to household appliances 9.

The output of the battery module 4 is connected to the magnetic control module 5. The output of the magnetic control module 5 is connected to the first induction coil module 6. The battery module 4 supplies electrical energy to the first induction coil module 6 via controlling the magnetic control module 5. The second induction coil module 7 is connected to household appliance 9 through the power control module 8 to supply electrical energy to the household appliance 9.

The magnetic control module 5 comprises a first main control module 51, a coil-driving module 52, a first interface module 53, a first circuit protection module 54 and a first wireless identification module 55. The coil-driving module 52, the first interface module 53, the first circuit protection module 54 and the first wireless identification module 55 are respectively connected to the first main control module 51. The input of the coil-driving module 52 is connected to the output of the battery module 4. The output of the coil-driving module 52 is connected to the first induction coil module 6. The coil-driving module 52 supplies driving electrical current to the first induction coil module 6.

The power control module 8 comprises a second main control module 81, a power output module 82, a second interface module 83, a second circuit protection module 84 and a second wireless identification module 85. The power output module 82, the second interface module 83, the second circuit protection module 84 and the second wireless identification module 85 are respectively connected to the second main control module 81. The output of the second induction coil module 7 is connected to the input of the power output module 82. The output of the power output module 82 is connected to the household appliances 9.

The second wireless identification module 85 is wirelessly linked to the first wireless identification module 55. The second wireless identification module 85 wirelessly transmits the information of the demand of electrical energy of household appliances 9 to the first wireless identification module 55, and the first wireless identification module 55 transmits the information to the first main control module 51. The first main control module 51 transmits a controlling signal to the coil-driving module 52 and drives the coil-driving module 52 to supply an appropriate electrical current to the first coil induction module 6. The current induced by the second induction coil module 7 via the electromagnetic induction between the second induction coil module 7 and the first induction coil module 6 transmits to the power control module 8. The electrical power that the second main control module 81 of the power control module 8 drives the power output module 82 to transmit to household appliances 9 is equal to the demand of electrical energy of household appliances 9.

The battery module 4 comprises a power supply unit 41 and a voltage transformation unit 42. The input of the voltage transformation unit 42 is connected to the external alternate current or direct current. The voltage transformation unit 42 is used to change the external alternate current to direct current and to reduce voltage or to adjust the voltage of direct current. The output of the voltage transformation unit 42 is connected to the input of the power supply unit 41. The output of the power supply unit 41 is connected to the magnetic control module 5.

The first interface module 53 comprises a first monitor unit 531 and a first operator unit 532. The first monitor unit 531 shows whether the magnetic control module 5 is supplying electrical current to the first induction coil module 6. Users can determine whether to supply electrical energy to the first induction coil module 6 via the first operator unit 532.

The first circuit protection module 54 comprises a first over-voltage protection unit 541, a first over-current protection unit 542 and a first overheat protection unit 543. The first over-voltage protection unit 541, the first over-current protection unit 542 and the first overheat protection unit 543 are used to protect the magnetic control module 5 out of over-voltage, over-current or overheat respectively to prolong its service life.

The second interface module 83 comprises a power monitor unit 831, a second monitor unit 832 and a second operator unit 833. The power monitor unit 831 shows consumed electrical energy of the household appliances 9 in working. The second monitor unit 832 shows whether the power control module 8 is supplying electrical energy to household appliances 9. Users can determine whether to supply electrical energy to household appliances 9 by the second operator unit 833.

The second circuit protection module 84 comprises a second over-voltage protection unit 841, a second over-current protection unit 842 and a second overheat protection unit 843. The second over-voltage protection unit 841, the second over-current protection unit 842 and the second overheat protection unit 843 protect the power control module 8 out of over-voltage, over-current or overheat respectively to prolong its service life.

When in use, the battery module 4 supplies electrical energy to the magnetic control module 5. The first wireless identification module 55 matches with the second wireless identification module 85 to form an information wireless transmitting path. The first main control module 51 obtains the information about the amount of power needed by the household appliance 9 via the information wireless transmitting path. Then the first main control module 51 drives the coil-driving module 52 to supply an appropriate electrical current to the first coil induction module 6. The first coil induction module 6 produces a magnetic field, which gets across the second induction coil module 7 to generate an induced current. The induced current of the second induction coil module 7 is inputted to the power control module 8. The second main control module 81 of the power control module 8 drives the power output module 82 to supply the electrical energy to household appliance 9. The electrical energy that the power output module 82 supplies is equal to the demand of electrical energy of household appliances 9.

The first wireless identification module 55 matches with the second wireless identification module 85 to ensure that the first main control module 51 obtain the information of the electrical energy demand of household appliance 9, and that the electrical energy supplied by the power output module 82 is equal to the electrical energy consumed by household appliance 9. This way, any one of the household appliances 9 can get electrical energy from the inductive power supply structure of the present invention, instead of that each household appliance 9 has its own power supply structure.

The battery module 4 comprises a power storage unit, and the magnetic control module 5 comprises a power management module. In controlling the main control module, in the off-peak time of electricity use, the electrical energy is stored in the power storage unit, and in the peak time of use of electricity the electrical energy stored in the power storage unit is supplied to household appliances 9, which can save power cost.

The foregoing description of the exemplary embodiment of the invention has been presented for the purposes of illustration and description. It is not intended to be exhaustive or to limit the invention to the precise form disclosed. Many modifications and variations are possible in light of the above teaching. All changes that come within the meaning and range of equivalency of the claims are to be embraced within their scope.

What is claimed is:

1. An inductive power supply structure, comprising:
a battery module;
an induction coil module; and
a magnetic control module connected to the induction coil module, wherein the magnetic control module comprises a main control module, a coil-driving module, an interface module, a circuit protection module and a wireless identification module; wherein the coil-driving module, the interface module, the circuit protection module and, the wireless identification module are all electrically connected to the main control module respectively.

2. The inductive power supply structure according to claim 1, wherein the interface module comprises a monitor unit and an operator unit.

3. The inductive power supply structure according to claim 1, wherein the circuit protection module comprises an over-voltage protection unit, an over-current protection unit and an over-heat protection unit.

4. The inductive power supply structure according to claim 1, wherein the magnetic control module further comprises a coil-detecting module electrically connected to the main control module; the induction coil module comprises a main induction coil and an assistant induction coil; wherein the main induction coil is electrically connected to the coil-driving module; the assistant induction coil is electrically connected to the coil-detecting module.

5. The inductive power supply structure according to claims 1, wherein the battery module comprises a power supply unit and a voltage transformation unit, wherein the power supply unit and the voltage transformation unit are electrically connected to the magnetic control module, and wherein the voltage transformation unit electrically connected to external alternate current or external direct current.

6. The inductive power supply structure according to claim 5, wherein the battery module further comprises a power storage unit, the power supply unit and the voltage transformation unit are electrically connected to the magnetic control module respectively, the voltage transformation unit is electrically connected to the power storage unit, the power storage unit electrically connected to the power supply unit, the magnetic control module further comprises a power-managing unit, wherein the power-managing unit is electrically connected to the main control module.

7. An inductive power supply system, comprising:
a battery module;
a magnetic control module electrically connected to the battery module, wherein the magnetic control module comprises a first main control module, a coil-driving module, a first interface module, a first circuit protection module and a first wireless identification module; and wherein the coil-driving module, the first interface module, the first circuit protection module and the first wireless identification module are respectively connected to the first main control module;
a first induction coil module;
a second induction coil module; and
a power control module electrically connected to the second induction coil module; wherein the power control module comprises a second main control module, a power output module, a second interface module, a second circuit protecting module and a second wireless identification module, wherein the power output module, the second interface module, the second circuit protecting module and the second wireless identification module are electrically connected to the second main control module, the power output module is electrically connected to a household appliance; the first wireless identification module provides appropriate electric current to the first induction coil module via the first and second wireless identification module, the first induction coil module generates a magnetic force which passes through the second induction coil module to generate an inductive current and the inductive current is input to the power control module; and wherein the second main control module drives the power output module to provide electric power to a household appliance equal to a power demand of the household appliance.

8. The inductive power supply system according to claim 7, wherein the first interface module comprises a first monitor unit and a first operator unit.

9. The inductive power supply system according to claim 7, wherein the first circuit protection module comprises a first over-voltage protection unit, a first over-current protection unit and a first overheating protection unit.

10. The inductive power supply system according to claim 7, wherein the second interface module comprises a second monitor unit and a second operator unit.

11. The inductive power supply system according to claim 7, wherein the second circuit protection module comprises a second over-voltage protection unit, a second over-current protection unit and a second overheating protection unit.
